(19) United States
(12) Patent Application Publication
(10) Pub. No.: US 2025/0349324 A1
(43) Pub. Date: Nov. 13, 2025

(54) REVINYL: MAGNETIC AND MECHANICAL AUDIO TRANSFER FOR PHONO CARTRIDGES

(71) Applicant: Michael Joseph Hewitt, Littleton, CO (US)

(72) Inventor: Michael Joseph Hewitt, Littleton, CO (US)

(21) Appl. No.: 18/661,610

(22) Filed: May 11, 2024

(51) Int. Cl. G11B 31/00

(52) U.S. Cl. CPC G11B 31/00

(57) ABSTRACT

The present invention, “Revinyl,” revolutionizes turntable audio playback with capabilities for both magnetic and mechanical audio transfers. This device enriches the traditional vinyl experience by enabling direct audio playback from digital sources without using physical records. Employing transducers, Revinyl generates a magnetic field that transmits audio signals directly to phono cartridges, producing clear stereo sound without stylus contact-thus preserving stylus durability. For cartridges unsuitable for magnetic interaction, it includes a grooved plate and flipper paddles for mechanical audio transfer. This dual functionality ensures compatibility across diverse turntable models. Revinyl also incorporates modern digital audio technologies like Bluetooth, Wi-Fi audio casting, and hardwired connections, offering users extensive flexibility to access a wide range of audio content. By eliminating the use of physical records and reducing stylus wear, Revinyl provides a sustainable, innovative solution that merges the analog appeal of vinyl with the convenience of digital technology.

### CROSS-REFERENCE TO RELATED APPLICATIONS

This non-provisional patent application claims the benefit of U.S. Provisional Patent Application No. 63/465,853, filed electronically with the U.S. Patent and Trademark Office on May 11, 2023, pursuant to 35 U.S.C. § 119 (e).

### FIELD

The present invention pertains generally to audio playback technologies, and more particularly to devices designed for enhancing audio signal transfer in phonographic systems. This invention falls within the field of consumer electronics, focusing on innovations that integrate digital audio streaming with traditional vinyl playback systems.

### BACKGROUND

### Overview

The realm of audio playback has undergone significant transformations with the resurgence of vinyl records, prized for their rich sound quality. Despite technological advancements in digital audio, vinyl playback systems have largely retained traditional mechanisms that limit their integration with modern digital audio sources.

### DESCRIPTION OF RELATED ART

Traditional phono cartridges, integral to vinyl systems, convert mechanical vibrations from vinyl grooves into stereo audio signals. Current systems utilize either moving magnet (MM) or moving coil (MC) cartridges, each with inherent limitations regarding sound quality, durability, and compatibility with digital audio formats. Additionally, most existing systems fail to leverage advancements in digital audio technology, restricting users to audio available only on vinyl.

### Problems with Existing Technologies

Existing phonographic playback systems are constrained by:
The physical wear and degradation of vinyl records with repeated play.
The need for the user to flip the vinyl record or change out the vinyl record every 15-25 minutes.
The inability to integrate seamlessly with digital audio sources, limiting the versatility of vinyl record players.
Dependence on the mechanical contact between the needle and vinyl, which can degrade audio quality and record and stylus longevity.
Records can become scratched and unplayable and often end up in landfills.

### Objective of the Invention

The objective of “Revinyl” is to revolutionize the vinyl playback experience by introducing a system capable of both magnetic and mechanical audio transfer, allowing for high-quality stereo audio playback directly from digital sources. This system uses a pair of transducers to transmit audio signals effectively, enabling clear stereo audio through phono cartridges. For phono cartridges that can be manipulated by the magnetic field created by the transducers, the fully magnetic audio transfer to the phono cartridge allows clear stereo audio transfer without physical contact of the stylus with the surface of the device. Thereby reducing wear and tear of the stylus. For phono cartridges that do not allow for magnetic audio transfer, the “Revinyl” system is equipped with a grooved plate and flipper paddles where the user can place the stylus and allows for mechanical transfer of stereo audio to the phono cartridge.

The system is designed to integrate seamlessly with most standard turntable systems manufactured since the mid-1940s. “Revinyl” enhances the user experience by merging the analog charm of vinyl records with the convenience of modern digital audio technologies. This is done by transferring digital signals sent to “Revinyl” via Bluetooth, Wi-Fi audio casting, hardwired audio connections, and local audio storage directly to the phono cartridge of a record player. Furthermore, by attaching the “Revinyl” system to old, worn vinyl records, it upcycles these records, giving them new life and functionality to play any digital or analog audio signal. This innovative approach not only extends the lifespan of vinyl records, keeping them out of landfills, but also broadens their usability, allowing for the enjoyment of a wider range of audio content through both wireless and wired systems.

### SUMMARY

The present invention, “Revinyl”, is designed to transform vinyl playback experience by introducing an advanced audio transfer system that operates without the need for traditional vinyl records. This system is capable of both magnetic and mechanical audio transfers, ensuring compatibility with a wide range of phono cartridges and turntable systems.

### Key Features:

1. Magnetic Audio Transfer: “Revinyl” incorporates a magnetic transfer method that uses transducers to create a magnetic field for transmitting audio signals directly to the phono cartridge. This feature allows for clear, high-quality stereo audio playback without physical contact, reducing mechanical losses and thereby preserving the stylus and avoiding any wear and tear typically associated with conventional needle-and-vinyl interaction. Additionally, amplifying magnets can be placed on top of the transducers to enhance the strength of the magnetic field and allowing the user to place their phono cartridge in the optimal position within the magnetic field.
2. Mechanical Audio Transfer: For turntable systems or cartridges that do not support magnetic transfer, “Revinyl” includes a grooved plate and flipper paddles where “Revinyl” can mechanically engage the stylus to receive audio signals. This dual functionality ensures that “Revinyl” can be used universally across different types of audio systems, enhancing its adaptability.
3. Digital Integration: The system is equipped with modern audio technology capabilities, including Bluetooth, Wi-Fi audio casting, and options for hardwired connections or local audio storage. These features allow users to stream audio from various digital sources directly to their turntable, merging the classic appeal of vinyl sound with the convenience and diversity and breadth of digital music libraries.

### Advantages

Preservation of Audio Equipment: By eliminating the need for physical vinyl records and reducing stylus wear, “Revinyl” extends the life of both stylus and the users vinyl collection.
Enhanced User Experience: Users can enjoy the rich, warm sound of vinyl playback without the risk of damaging valuable records, dealing with the limitations of vinyl collections. “Revinyl” can be set to play for extended periods, greatly reducing the need for the user to change out or flip records.
Upcycling of Existing Equipment: “Revinyl” provides old turntable systems with new capabilities, allowing them to function with the latest digital audio technologies and thus broadening their usability.

Objective: The invention aims to provide a comprehensive solution that preserves audio equipment, enhances sound quality and functionality, and bridges the gap between analog charm and digital convenience. This innovative approach not only makes vinyl playback more accessible but also more sustainable and adaptable to modern audio preferences.

### BRIEF DESCRIPTION OF THE DRAWINGS

The following drawings form part of the present specification and are included to further demonstrate certain aspects of the present invention. These drawings illustrate various embodiments of the invention and, along with the description, serve to explain the principles and operations of the invention. Each item will be explained in more detail with reference to the example embodiments shown in the drawings, in which:

FIG. 1 is an exploded view showing all embodiments.

FIG. 2 is an isometric view of the device after assembly.

FIG. 3 is a view of the toner arm of the record player resting in the Toner Arm Saddle as well as the placement of the phono cartridge above the Audio Transmission Disc Plate and between the Amplifying Magnets.

FIG. 4 is a view of the device from below with the Secondhand Vinyl or Vinyl Replica Removed.

FIG. 5 is a detailed view of the Audio Transmission Disc and its parts.

### DETAILED DESCRIPTION OF THE DRAWINGS

In the following detailed descriptions, the device according to the teachings for this application is in the form of a consumer electronic device that is used in conjunction with most manufactured record players, or turntables acquired since the mid-1940s. It should be noted that while the device is in the shape of a record within the teachings of this application, and can be played on a turn table, magnetic and mechanical audio transfer to a phono cartridge can be used in other devices as well, such as an stationary addition to record player turn tables.

### Turntable Motion Separation Components:

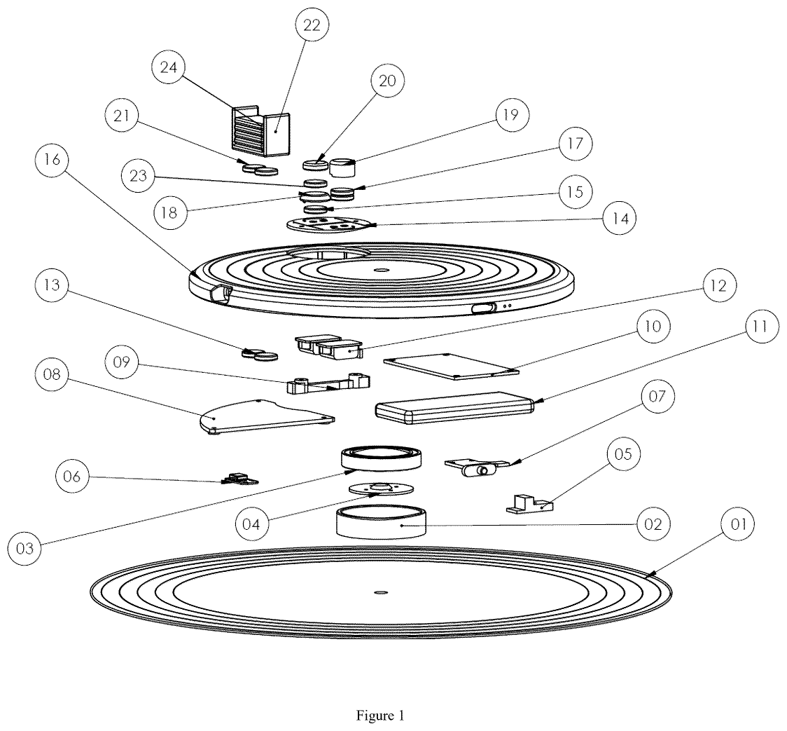

Embodiment 01 represents either a secondhand vinyl record or a replica of a vinyl record. This embodiment is the foundation upon which the entire system is placed. This embodiment not only serves as an aesthetic base for the system but also serves as the first embodiment of the system that allows only a portion, embodiment 01, 02 and 03, spin while the rest of the device and remaining embodiments shown in FIG. 1 remain stationary. Because the majority of record players lack the ability to stop the turntable from spinning while the toner arm of the record player is positioned over the turntable (FIG. 3), it is required that the motion be separated from the rest of the device. This separation of movement allows the transducers to remain in-line and just below the phono cartridge. It has also been observed that the slight wobble of the device due to the spinning helps to keep the magnetic field coupled with the coil and magnets of the phono cartridge. This allows the transducers to be operated at lower input levels and improves sound quality.

Embodiment 02 represents the Lower Bearing Housing. The Lower bearing housing is adhered to embodiment 01 to create a single rigid structure. In the case that a vinyl replica is used Embodiments 01 and 02 are one solid piece. There are 5 holes in the bottom of embodiment 02. When a secondhand vinyl is used, no less than one hole and up to four holes are drilled into the vinyl record. These holes allow screws to pass through the vinyl record to attach embodiment 04, the Bearing Lock to embodiment 16, The Main Component Housing. In the case of assembling using a vinyl replica, no drilling is required as the four holes are present during the manufacturing of the replica. The fifth, center hole is used to place the device on the turntable using the center pole present on the turntable

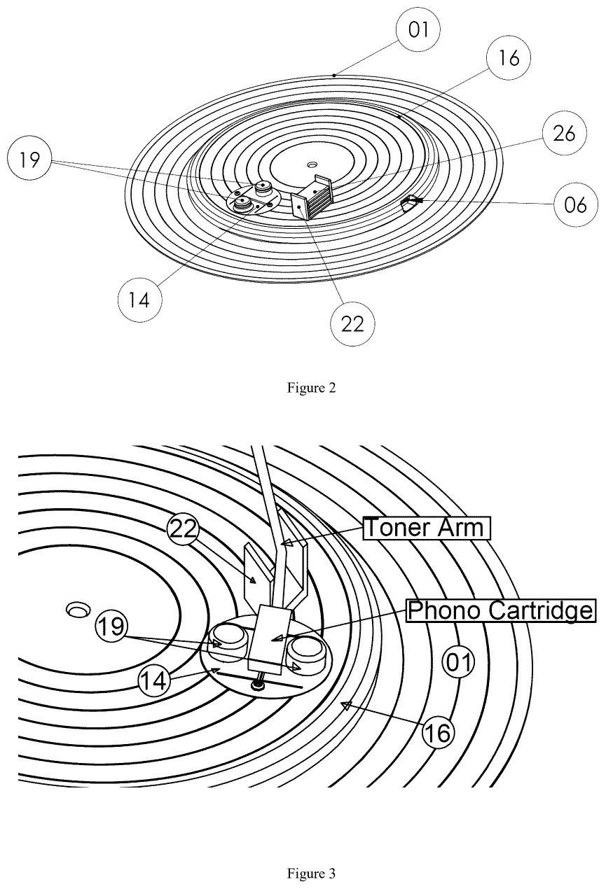

Embodiment 03, The Bearing, fits snug tight into embodiment 02 and is difficult to remove after being set. Prior to the Bearing being set, embodiment 04, the Bearing Lock, is placed inside the Bearing Housing. This is then attached to the Main Component Housing, in the method described above, only after the rest of the device is assembled shown in FIG. 2.

### Toner Arm Saddle Apparatus:

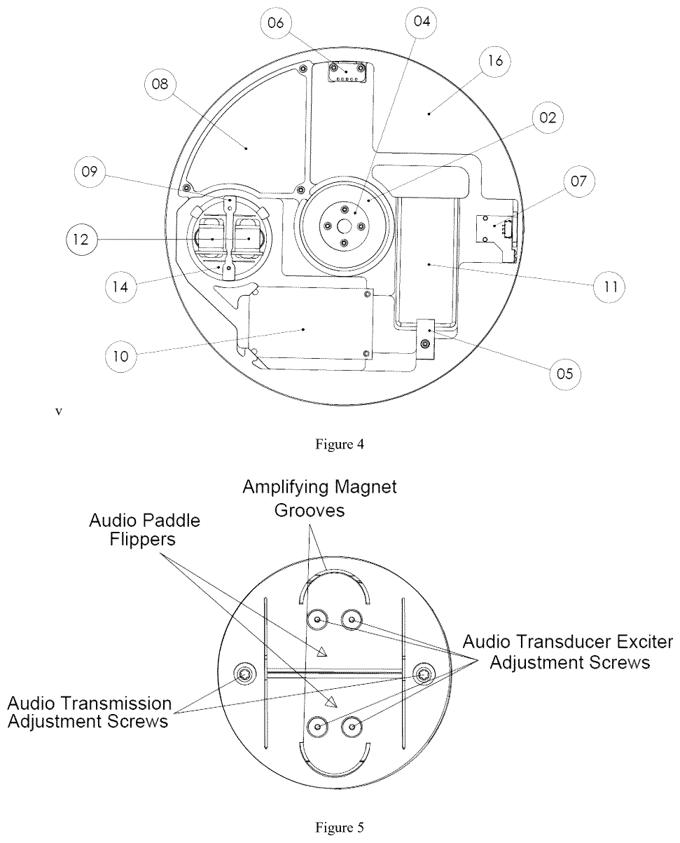

The Toner Arm Apparatus is the collection of components that use the toner arm of the record player to keep the Main Component Housing Stationary. The shape and angle in which the toner arm of a record player intersects the turntable area can vary. This requires that a moveable Toner Arm Saddle be incorporated into the design of the device. Within the Main Component Housing, there is a cavity in which two magnets, embodiment 13 are sealed inside. Embodiment 08 is the cover to this cavity and is connected to the main component housing using 3 screws. The area of the cavity can be seen in FIG. 4. Embodiment 22 is the Toner Arm Saddle. Embodiment 21 is a pair of magnets that are fixed inside of the base of the Toner Arm Saddle. When the device is assembled, embodiments 13 and 21 and by extension embodiment 22 are magnetically connected. The cavity inside of the Main Component Housing allows for the movement of the Toner Arm Saddle to slide freely on the surface of the Main Component Housing in two dimensions. With the toner arm of the record player placed within the Toner Arm Saddle, the placement and angle of the toner arm can be adjusted to place the phono cartridge in the desired position over embodiment 14, the Audio Transmission Disc (FIG. 3). With the toner arm in place wedged inside of the Toner Arm Saddle, the magnetic force of embodiments 13 and 21 are strong enough to stop the movement of the Main Component Housing with the aid of the Turntable Separation Components described above. Embodiments 24 are Toner Arm Riser Plates. These Plates allow for the adjustment of the toner arm and phono cartridge to be closer or further away from the surface of the Audio Transmission Disc. The Toner Arm Riser Plates are removeable and are connected and held in place to the Toner Arm Saddle via magnets embedded within the aesthetic housing of the plates.

### Power and Audio Input/Output Electronics:

Embodiment 11 is the Lithium Polymer Battery (LiPo). This powers all of the electronics within the device, including the Audio Power Amplifier, Bluetooth/Wi-Fi casting receiver, transducers, and indicator LEDs. Embodiment 05 is the Battery Clip. The Battery Clip attaches to the Main Component Housing by a single screw and holds the battery in place along with a cavity in the Main Component Housing that one end of the battery slips into. This can be seen in FIG. 4.

Embodiment 06 is one of three Printed Circuit Boards (PCB). This PCB is the Power and Input PCB. This PCB contains the USB input that provides data input and power input to power the device and for charging the Lipo Battery. There is also a Micro SD card slot for removable storage of audio files. The last item on this board is a ⅛th inch audio jack input. Together, these items support the hardwired capability of delivering audio to the device.

Embodiment 07 is the second PCB. This is the Power Switch PCB. It contains the power switch to turn the device on and off and also contains the LED indicator lights that provide visual confirmation of device power up and over the air connectivity of Bluetooth and Wi-Fi casting connections.

Embodiment 10 is the last PCB. This is the Power Amplifier PCB. It contains the Battery Charging Circuit, The Bluetooth and Wi-Fi Casting Circuitry and the Power Amplifier Circuitry.

It should be noted that while the drawing contains three PCB boards, these boards may be consolidated and/or split and or rearranged to maximize cost and efficiency.

Embodiment 12 are a pair of Audio Transducer Exciters. The use of two exciters allows for the transmission both magnetically and mechanically of stereo audio. The transducers are capable of producing audible frequencies between 20 Hz to 20 kHz. The Audio Transducer Exciters create a magnetic field that is capable of moving the magnets and coils located within the phono cartridge of the record player. The Audio Transducer Exciters are installed on the underside of embodiment 14, the Audio Transmission Disc with 4 small screws. Shown in FIG. 5, adjusting these screws can increase or decrease the intensity of the vibrations created by the transducers. By attaching the Audio Transducer Exciters to the Audio Transmission Disc, the Transducer create a mechanical vibration that vibrate a set of Audio Paddle Flippers located on the Audio Transmission Disc that are capable of transmitting the audio to the phono cartridge via the stylus connected to the cartridge of a record player.

### Audio Transmission Apparatus:

The Audio Transmission Apparatus contains all of the components necessary to achieve audio transmission to the phono cartridge. Embodiment 09 is the Audio Disc Locking Bone. The inner ledge of the large hole in the Main Component Housing is sandwiched between the Audio Disc Locking Bone and the Audio Transmission Disc and held together by two screws. When the screws are loose, the Audio Transmission Disc is able to rotate freely. This allows the user to align the Audio Transmission Exciters and the small groove in the Audio Transmission Disc to be parallel with the phone cartridge and toner arm of the record player. There are extrusions within the inside of the Main Component Housing that will stop the disc from being turned 360°, so as to not disconnect the wiring to the Audio Transducer Exciters. Once the Transducers are aligned with the cartridge as shown in FIG. 3, the screws can be tightened down to ensure that the Audio Transmission Disc will remain fixed within the large hole in the Main Component Housing. These Screws are shown on FIG. 5.

The magnetic field created by the Audio Transducer Exciters can be amplified and moved above the Audio Transmission Disc by using amplifying magnets that are placed above the Transducers. Shown in FIG. 1 are two different configurations of these magnetic field amplifying units. Embodiments 15, 23, 18 and 20 show a stackable configuration where embodiments 15 and 23 are the Amplifying Magnets and embodiments 18 and 20 are the aesthetic housing of the stackable units. Embodiments 19 and 17 make up a single unit that is the same height of the stackable units where embodiment 17 is a stack of two Amplifying Magnets and embodiment 19 is the aesthetic housing. Both the stackable unit and the single unit snap into the half circle grooves of the Audio Transmission Disc shown in FIG. 5. This ensures that the magnets are locked into place when in use to avoid the magnets attaching themselves to the housing of the phono cartridge. The amplifying magnets are optional when magnetic transfer of audio is being utilized and are not needed when using the device with a cartridge that is not capable of audio transmission via a magnetic field and the stylus is instead placed in the groove between the Audio Paddle Flippers.

### Advantages of the Present Invention

The teachings of the present application offer numerous benefits. While different embodiments or implementations may yield one or more of these advantages, it is important to note that the list provided here is not exhaustive. Additional advantages, not described herein, may also be realized. For instance, one advantage of the teachings of this application is that it allows for an audio playback system that significantly reduces wear and tear on both stylus and vinyl records. Another advantage is that the Revinyl system facilitates seamless integration with existing turntable systems, enhancing user interaction without compromising traditional aesthetics. Yet another advantage is that it offers a design that supports both digital and analog audio inputs, promoting versatility and user convenience.

Although the teachings of the present application have been described in detail for the purpose of illustration, it is understood that such detail is solely for that purpose, and variations can be made by those skilled in the art without departing from the scope of the teachings. For example, the system has been described as integrating with standard turntables, but it is understood that the setup could be adapted to work with non-standard or custom-built turntables. Furthermore, the system has been illustrated with components configured in a particular arrangement, but it should be understood that these components could be reconfigured or redesigned according to different user needs or technological advancements.

Additionally, while the teachings have been primarily described in terms of enhancing vinyl record players, it should be appreciated that similar principles could be applied to other audio playback technologies or devices that benefit from improved audio quality and reduced mechanical wear. There are many alternative ways of implementing the methods and apparatus of the teachings of this application.

Features described in this specification may be used in combinations other than those explicitly described. It should also be noted that this specification endeavors to highlight features of the invention believed to be of particular importance; however, protection is sought for any patentable feature or combination of features referred to and/or shown in the drawings, whether or not particular emphasis has been placed on them.

The term “comprising” as used in the claims does not exclude other elements or steps, and the use of “a” or “an” does not exclude a plurality. A single unit or means may fulfill the functions of several items or means recited in the claims.

1. An audio playback device for turntables, comprising:
A set of transducers configured to generate a magnetic field for transferring audio signals to a phono cartridge,
A mechanism for mechanical transfer of audio involving a grooved plate that engages with a stylus,
A digital connectivity interface capable of connecting to external digital audio sources, including but not limited to Bluetooth, Wi-Fi, wired connections, and removable storage media,
A tonearm saddle apparatus configured to manipulate the position and movement of the playback device on the turntable by interacting with the tonearm.

2. A method for transferring audio to a phono cartridge in a turntable system, comprising:
Generating a magnetic field through transducers configured within the turntable system to transmit audio signals without physical contact,
Aligning the magnetic field with a phono cartridge capable of receiving magnetic audio signals,
Transmitting audio signals via the magnetic field to achieve audio playback,
Engaging a stylus with a grooved plate integrated within the turntable system for mechanical audio transfer when magnetic transfer is not feasible,
Modulating the magnetic field and adjusting the pressure exerted by the stylus on the grooved plate to enhance audio quality and volume,
Stopping or separating the rotation of the device using the tonearm via a movable saddle connected to the device magnetically.

3. A multifunctional kit for upgrading existing turntable systems, comprising:
The audio playback device as claimed in claim 1,
A set of instructions for retrofitting existing turntable systems,
A software component for managing audio signal processing within the system, tailored to optimize the switch between magnetic and mechanical transfer modes,
A hardware component designed for precise placement and adjustment of the phono cartridge in relation to the playback device,
Additional components for modifying the device to support multiple types of phono cartridges, including both moving magnet and moving coil cartridges.
